(19) United States
(12) Patent Application Publication
(10) Pub. No.: US 2017/0106273 A1
(43) Pub. Date: Apr. 20, 2017

(54) INTERACTIVE VIDEOGAME USING A PHYSICAL OBJECT WITH MULTIPLE MACHINE-READABLE COMPONENTS

(71) Applicants: Daniel M. Doptis, Troy, NY (US); Robert Leyland, Novato, CA (US)

(72) Inventors: Daniel M. Doptis, Troy, NY (US); Robert Leyland, Novato, CA (US)

(21) Appl. No.: 14/955,817

(22) Filed: Dec. 1, 2015

Related U.S. Application Data
(60) Provisional application No. 62/242,913, filed on Oct. 16, 2015.

(51) Int. Cl. A63F 13/235; A63F 13/825; A63F 13/65; A63F 13/24

(52) U.S. Cl. CPC A63F 13/235; A63F 13/24; A63F 13/825; A63F 13/65

(57) ABSTRACT

A videogame includes a peripheral device that senses the presence and identity of a physical object near or on the peripheral. The physical object includes multiple identification components, for example, RFID tags. The identification components correspond to one or more videogame states and can be used to conduct gameplay.

### CROSS REFERENCE TO RELATED APPLICATION

This application claims the benefit of the filing date of U.S. Provisional Patent Application No. 62/242,913, filed on Oct. 16, 2015, the disclosure of which is incorporated by reference herein.

### BACKGROUND OF THE INVENTION

The present invention relates generally to videogames and, more particularly, to a videogame that incorporates physical objects such as toys.

Toys such as action figures, cars, robots, weapons, buildings, and others provide countless hours of fun and enjoyment for many. Toys often serve as a vehicle for expanding the imagination and cultivating creativity.

Videogames also provide fun and enjoyment for many. Videogames allow game players to participate in a variety of simulated activities. Videogames allow game players to perform roles and experience activities that the game players may not be able or desire to experience directly, whether due to cost, danger, or equipment concerns, or simply due to a role or activity being a fantasy.

These experiences have generally been mutually exclusive, and users have been forced to sacrifice one form of play in favor of the other.

### BRIEF SUMMARY OF THE INVENTION

One aspect of the present invention relates to a videogame, comprising: an MID reader comprising at least one substantially flat surface; a toy comprising a plurality of portions, each portion comprising an RFID tag readable by the RFID reader; wherein the plurality of portions of the toy are configured such that when the toy is placed on the at least one substantially flat surface of the RFID reader, a first RFID tag of the toy, and only the first RFID tag of the toy, is sufficiently proximate the RFID reader such that the RFID reader can read information from the first RFID tag; and wherein information read by the RFID reader from the first RFID tag is used by a videogame.

These and other aspects of the invention are more fully comprehended upon review of this disclosure.

### BRIEF DESCRIPTION OF THE FIGURES

FIG. 1A illustrates an example of a videogame system in accordance with aspects of the invention;

FIG. 1B illustrates a cube-shaped physical object with six machine-readable components in accordance with aspects of the invention;

FIG. 1C illustrates a cross-sectional view of the cube-shaped physical object of FIG. 1B;

FIG. 2 is a block diagram of a videogame console in accordance with aspects of the invention;

FIG. 3 is a block diagram of a videogame peripheral in accordance with aspects of the invention;

FIG. 4 is a flowchart of a process for communication with toys in accordance with aspects of the invention;

FIG. 5 is a flowchart of a process for identifying toys in accordance with aspects of the invention;

FIG. 6 is a flowchart of a process for selecting a toy in accordance with aspects of the invention;

FIG. 7 is a flowchart of a process for communicating commands with a toy in accordance with aspects of the invention;

FIG. 8 is a flowchart of a process for communication with a videogame peripheral in accordance with aspects of the invention;

FIG. 9 is a diagram of data structure in accordance with aspects of the invention;

FIG. 10 is a flowchart of a process for changing characters present in a videogame in accordance with aspects of the invention; and

FIG. 11 is a flowchart of a process for adding characters in a videogame in accordance with aspects of the invention;

FIG. 12 is a flowchart of a further process for adding characters in a videogame in accordance with aspects of the invention;

FIG. 13 is a flowchart of a process for events that update toy information in accordance with aspects of the invention;

FIG. 14 is a flowchart of a process for writing information to a toy in accordance with aspects of the invention; and

FIG. 15 is a flowchart of a process for conducting game play using a game-related physical object in accordance with aspects of the invention; and

FIG. 16 is a flowchart of a process for conducting game play using a game-related physical object in accordance with aspects of the invention.

### DETAILED DESCRIPTION

Exemplary System

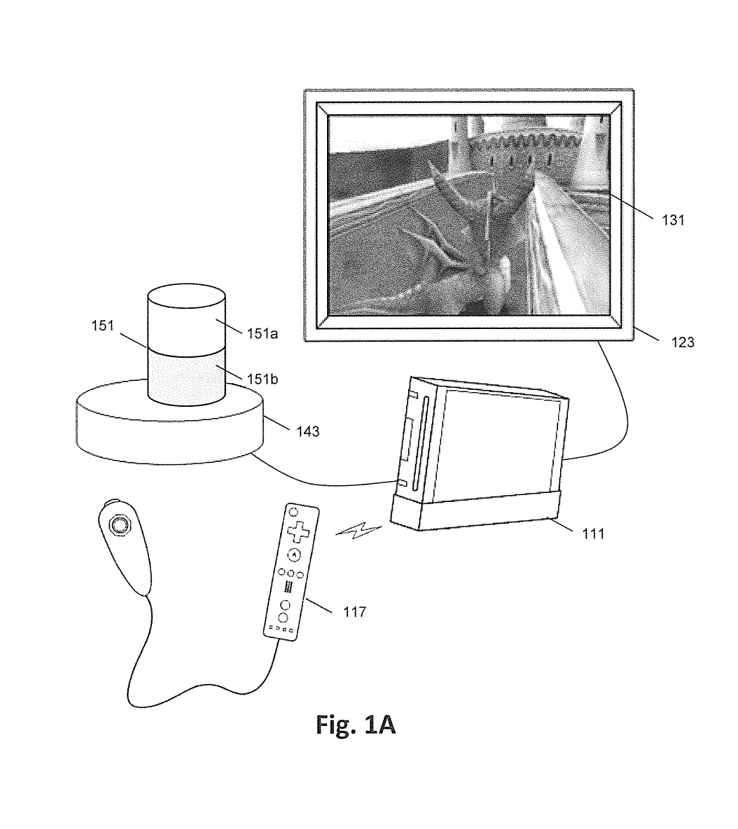

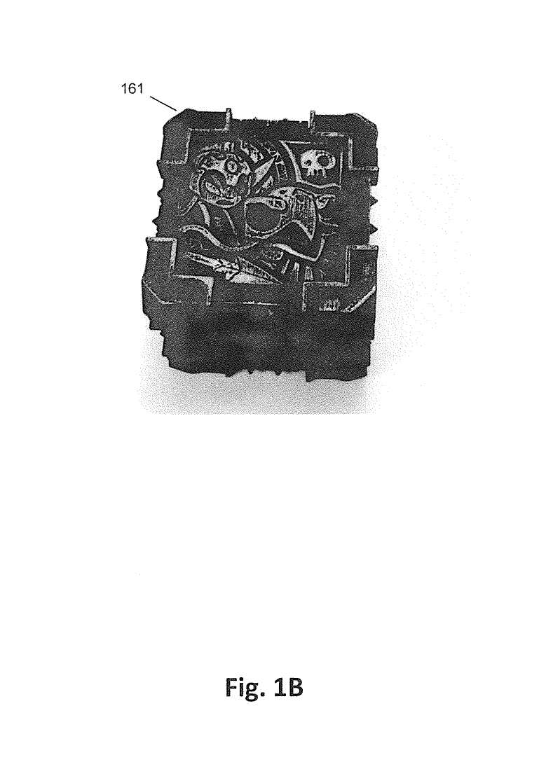

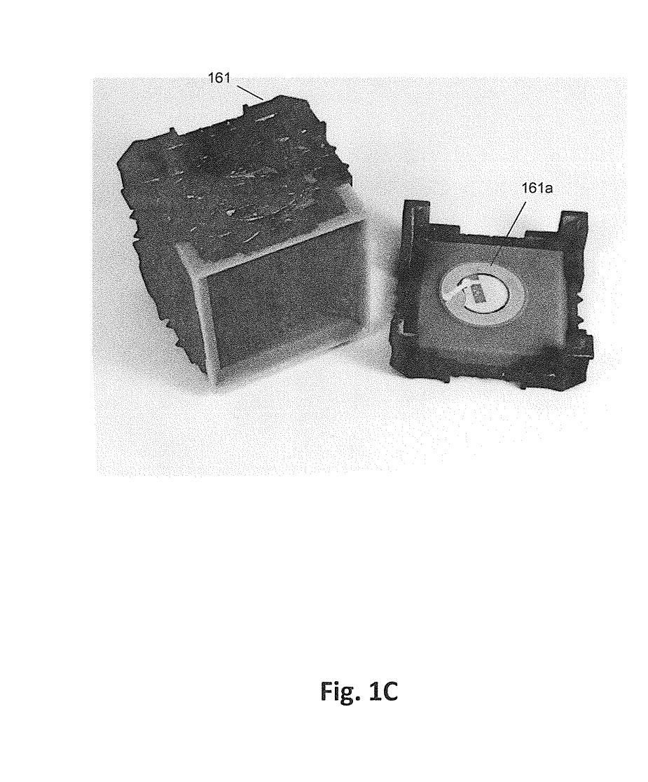

FIG. 1A illustrates an example of a videogame system in accordance with aspects of the invention. The videogame system includes a game console 111 with a processor for executing program instructions providing for gameplay and associated circuitry, user input devices such as a game controller 117, a display device 123, and a detection device 143, which in various embodiments is configured to read information from and write information to an object such as a toy, but for convenience will generally be referred to as a detection device or peripheral. The processor, responsive to inputs from the user input devices and the detection device, generally commands display on the display device of game characters in and interacting with a virtual world of gameplay and possibly each other. In addition, the processor, responsive to inputs from the detection device, may also add characters and objects to the virtual world, with the characters able to manipulate the added objects and move about the virtual world. For example, the processor may include characters in gameplay based on inputs from the detection device, and the processor may control actions and activities of game characters based on inputs from the user input devices.

The instructions providing for gameplay may be stored on removable media, for example, an optical disk. Accordingly, the game console may include an optical drive, for example, a DVD-ROM drive, for reading the instructions for gameplay. In some embodiments, instructions providing for gameplay may be downloaded from remote computing device and stored on a storage drive such as a solid-state drive or hard-disk drive. In some embodiments, the game console may be a personal computer, including similar internal circuitry as herein described, as well as, for example, a built-in display and built-in user input devices, such as a keyboard and a touch pad.

The display device is generally coupled to the game console by a cable, although in some embodiments a wireless connection may be used. In many embodiments, the display device is a liquid crystal display. In some embodiments, the display device is a television. A display screen 131 of the display device displays video images of game play, generally as commanded by the processor or other associated circuitry of the game console. In the embodiment of FIG. 1A, the display screen shows a screenshot of videogame play. As illustrated, the screenshot shows a display of a character, generally controlled by and animated in accordance with user inputs, approaching an inanimate item in the form of what may be considered a castle.

The detection device (also referred to herein as the peripheral or peripheral device), in some embodiments and as shown in FIG. 1A, has at least one substantially flat upper surface for placement of toys (or other physical objects) thereon. Each toy includes a machine-readable identifier, for example, a radio-frequency identification (RFID) tag, a bar code, or other identifier. The machine-readable identifier may be sensed, read, and/or written by the detection device. The machine-readable identifier may include a numeric identifier. The machine-readable identifier allows the detection device, or the processor of the game console, to distinguish one toy from other toys, and the machine-readable identifier may therefore be considered to include a toy identifier. Each particular toy generally has its own distinct identifier. In some embodiments, the detection device has a plurality of substantially flat upper surfaces for placement of toys thereon, each capable of sensing, reading, and/or writing a toy's machine-readable identifier.

The game player generally places game toys, for example physical object 151 as shown in FIG. 1A, on the flat surface of the detection device during gameplay. In some embodiments, the toys may be in the form of and representative of game items such as game characters, vehicles, weapons, locations, buildings, or other game items. Alternatively, toys may be in the form of items related to the game, but not representative of game items.

Each toy includes machine-readable information, for example, memory, a radio-frequency identification (RFID) tag, or a barcode. In some embodiments, the machine-readable information may be encoded in the physical features of the toy itself or embedded on the surface of the toy. As discussed, the machine-readable information may be sensed, read, and/or in some embodiments written, by the detection device, in some embodiments indirectly by way of sending data and commands to the toy to write the data to memory of the toy. The machine-readable information may include one or more numeric identifiers, commands, programs, or any other information relevant to the videogame. In some embodiments, the machine-readable information allows the detection device, or the processor of the game console, to distinguish one toy from other toys, and the machine-readable information may therefore be considered to include a toy identifier, and in some embodiments, each particular toy has its own distinct identifier. In addition, in many embodiments the machine-readable information includes additional information about a corresponding game character or item, including in some embodiments, the status of the game character or item in a game.

When a toy is read by the detection device, the detection device provides the game console an indication of the identifier and status information of the toy, and generally the processor of the game console commands display of a corresponding game item (e.g., character, vehicle, weapon, location, building, or other game item) or otherwise makes the corresponding game item available in gameplay. In some embodiments, multiple toys may be detected and made available for gameplay, either by a single reader in the detection device or, in some embodiments, by multiple readers in the detection device, each corresponding to a unique detection area of the detection device. For example, when a hat toy and a character toy are concurrently on the detection device, the corresponding character in the game may possess the corresponding hat. Thus, videogame play may be affected by use of real world objects, objects which may also be utilized for play and/or observation separate from videogame play. In some embodiments, and as discussed in more detail herewith, the information read from the toy may be used to effect a change in the state of the videogame

Physical Objects with Multiple Machine-Readable Components

According to aspects of the invention, a physical object may comprise a plurality of portions, each comprising a machine-readable component. For example, physical object 151 of FIG. 1A comprises two portions 151a and 151b, each comprising a machine-readable component (not shown). Although physical object 151 comprises two portions with machine-readable identifiers, other embodiments of physical objects in accordance with the present invention may comprise additional portions, each with its own machine-readable component. For example and without limitation, FIG. 1B depicts a cube-shaped physical object 161 with six machine-readable components (not shown), one in each side of the cube. In various embodiments the cube-shaped physical object 161 may be used in place of the physical object 151 in the system of FIG. 1A. FIG. 1C depicts a cross sectional view of the cube-shaped physical object 161 of FIG. 1B. From this view, a machine-readable identifier 161a of one side of the cube-shaped physical object 161 can be seen. Any form of physical object may be used in accordance with the principles discussed herein. For example, a cross-shaped object may be used, with machine-readable components embedded in each of the four “arms.” A pyramid-shaped object may also be used, with machine-readable components embedded in each surface.

In some embodiments, one or more portions comprising a machine-readable component may be considered a stand or base portion of the physical object, which is capable of supporting the physical object when placed on a surface. As examples, each portion 151a and 151b of physical object 151 is a stand/base portion of the physical object. Likewise, each side of cube-shaped physical object 161 is also a stand/base portion of the physical object.

In some embodiments, the physical object is designed such that when placed on a detection device or peripheral, only one machine-readable component of the physical object can be detected, sensed, and/or read by the detection device. This may be achieved, in some embodiments, by designing the physical object such that only one of the machine-reachable components is within a read range of the detection device when placed on the detection device. For example, in FIG. 1A, the detection device's read range is such that it can only read the machine-readable identifier of portion 151b (e.g., the portion in closest proximity to the detection device).

Gameplay

According to aspects of the invention, a user may conduct gameplay by placing the physical object on the peripheral. The identification information stored in one or more of the plurality of the physical object's machine-readable identifiers may be read via the detection device or peripheral and used to conduct gameplay.

In some embodiments, information read from machine-readable identifiers may be used to change one or more states of the videogame. Non-limiting examples of videogame states include time of day, day or night, whether certain characters or character classes are awake or asleep, whether certain abilities or characteristics are enabled for certain characters or character classes, weather, the level or effect of gravitational forces, the rate at which time passes, a damage multiplier/reducer for certain characters or character classes, whether the videogame is in a bonus state, magic state, technology state, or some other defined state of the videogame. In some embodiments, one or more changes in videogame states may provide one or more advantages to the user or allow the user to overcome an obstacle, challenge, or puzzle.

In some embodiments, information read from machine-readable identifiers may be used to change the virtual character controlled by the user. For example, physical object 161 may allow a user to switch between six characters depending on which side was placed on the detection device. One of ordinary skill will recognize that in some embodiments, the machine-readable identifiers in the various portions of a physical object may relate to some mix of state information, character information, or some other information relating to gameplay.

In some embodiments, the information in the machine-readable identifier of a first portion of the physical object corresponds to the first portion of the physical object. For example, a first side of cube-shaped physical object 161 may be decorated with a representation of a first character, and the machine-readable identifier embedded in the first side may be an identifier for the first character. However, in other embodiments, the information in the machine-readable identifier of a first portion of the physical object may correspond to a second portion of the physical object. For example, the machine-readable identifier in a given side of the cube-shaped physical object 161 may correspond to the character depicted on the opposing side of the cube. In this way, when the character identifier read by the detection device will correspond with the character displayed on the top surface of the cube-shaped physical object. Other arrangements and pairings of machine-readable identifiers and physical object portions may be used.

Exemplary Processor and Associated Circuitry

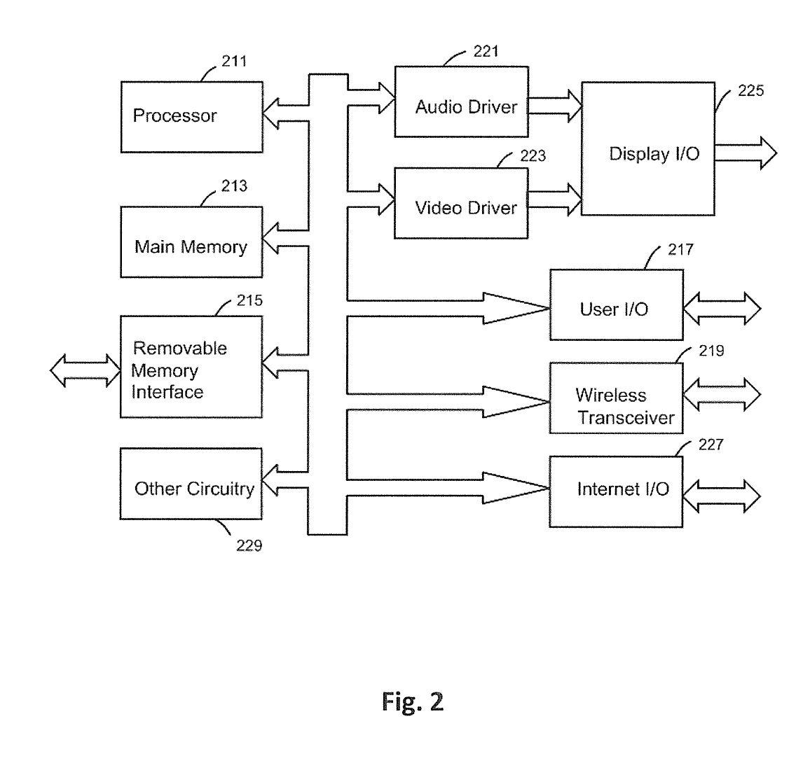

FIG. 2 is an example of a block diagram of a processor and associated circuitry, for example, for a game console, useful in accordance with aspects of the invention. As shown in FIG. 2, a processor 211 is connected to other components via a bus. The other components include a main memory 213 and a removable memory interface 215 generally coupled to a removable memory device, for example, a DVD-ROM drive. The processor may execute instructions retrieved from the removable memory device to control game play and store game state information in the main memory. For example, the instructions may be for determining possible movements, positions, and locations of a game character.

The processor is coupled to an audio driver 221 and a video driver 223. The audio driver produces sound signals and the video driver produces image signals. The sound signals and image signals are transmitted from the game console via a display I/O device 225. The display I/O device generally supplies the sound and image signals to a display device external to the game console. Sound signals may also be supplied to a peripheral device such as a toy detection device.

The processor may also be coupled to a user I/O device 217, a wireless transceiver 219, an Internet I/O device 227, and other circuitry 229. The user I/O device may receive signals from a toy reader and/or signals from a keyboard, a mouse, and/or a game controller, with generally the keyboard, mouse, and/or controller being used by a user and providing user inputs, for example, during game play. Alternatively or additionally, the game console may receive user inputs via the wireless transceiver. The Internet I/O device provides a communication channel that may be used, for example, for multiple player games.

Exemplary Videogame Peripheral/Detection Device

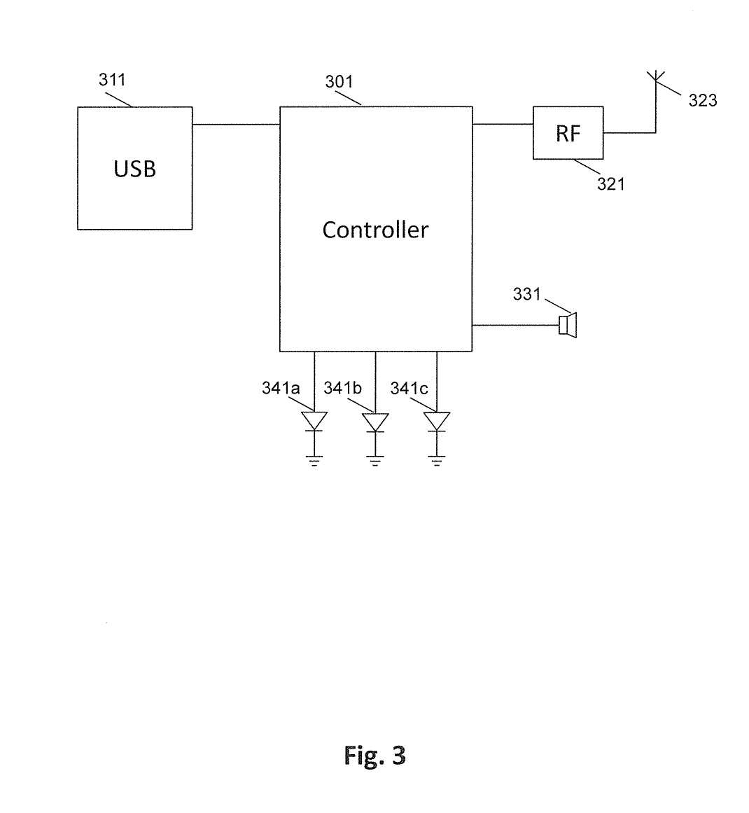

FIG. 3 is a block diagram of a videogame peripheral in accordance with aspects of the invention. The peripheral may be used in some embodiments as the detection device of FIG. 1. The peripheral may be used to provide information from the toy to a game console and, in some embodiments, from the game console to the toy or from one toy to another toy. Accordingly, the peripheral includes a universal serial bus (USB) interface 311 to communicate with the game console. In some embodiments, the peripheral may use a different interface, for example, a wireless interface for communication with the game console. The information communicated between the peripheral and the game console may be encrypted, and the information read from or written to the toy by the peripheral may also be encrypted.

The peripheral also includes a radio-frequency (RF) interface 321 to communicate with toys. In many embodiments, the radio-frequency interface is a radio-frequency identification (RFID) interface. In some embodiments, other wireless interfaces may be used, for example Bluetooth or Wi-Fi. In other embodiments, the peripheral may include a different interface for communicating with toys, such as an optical interface or a wired interface.

In one embodiment of an optical interface, the toy includes a light source, for example an LED, to provide information of the machine-readable information and a photodiode to receive information of commands, with circuitry operable within the toy to provide for associated operation of the LED and photodiode in performing communication functions. Power may be provided to the toy by way of a battery, by way of RFID operations, or by other sources. In such an embodiment, the toy reader similarly includes a photodiode and LED for communication with the toy.

In another embodiment, the peripheral includes an imaging device, for example a charge-coupled device (“CCD”) and associated circuitry. In such embodiments, the imaging device may generate an image, for analysis by the peripheral or in most embodiments by the game console, with the image providing information related to the toy. In some embodiments, identity of the toy may be determined by information embedded in the surface or the toy or by the shape or other features, such as color or reflectivity, of the toy or portions of the toy. Similarly, identity and other information of the toy may be provided by image information placed on the toy, including, for example, information of stickers placed on the bottom of the toy, placed either prior to receipt of the toy by a user or by the user, in which case the information may be changed by the user in accordance with gameplay results. The toy may instead or in addition include barcode or barcode-like information, with the peripheral including barcode scanning components.

In some embodiments, the peripheral comprises a plurality of wireless, optical, and/or wired components for sensing, reading from, and/or writing to a plurality of toys, either simultaneously or otherwise. Further, in some embodiments, the functionality of the peripheral may be included in the game console itself. For example, the game console may include one or more of the discussed wireless, optical, or wired components for sensing, reading from, and/or writing to one or more toys.

The peripheral includes a controller 301 that is coupled to the USB interface and the radio-frequency interface. The controller adapts the signals between protocols used by the two interfaces. In some embodiments, the controller communicates with the radio-frequency interface based on commands received over the USB interface. For example, the controller may receive commands to determine what toys are present on the peripheral or to read from or write to a particular toy. In other embodiments, the controller may independently communicate with the radio-frequency interface and supply resulting information to a game console over the USB interface. For example, the controller may, via the radio-frequency interface, regularly detect what toys are newly present on the peripheral and report the detected toys to the game console via the USB interface. The controller generally includes a programmable device such as a microprocessor performing program instructions. The program instructions may be stored in the peripheral as firmware or downloaded from the game console.

The peripheral also includes, in some embodiments, a loudspeaker 331. The loudspeaker provides audio signaling to game players and the signaling may relate to a particular toy present on the peripheral. In some embodiments, the peripheral includes visual indicators such as light-emitting diodes 341a-c. The diodes may, for example, be illuminated with intensities or colors according to characteristics of the toy or to signal performance in the videogame of characters associated with toys on the peripheral. Both the loudspeaker and visual indicators are coupled to the controller. The controller signals the loudspeaker and visual indicators to operate according to commands received via the USB interface.

Exemplary Processes

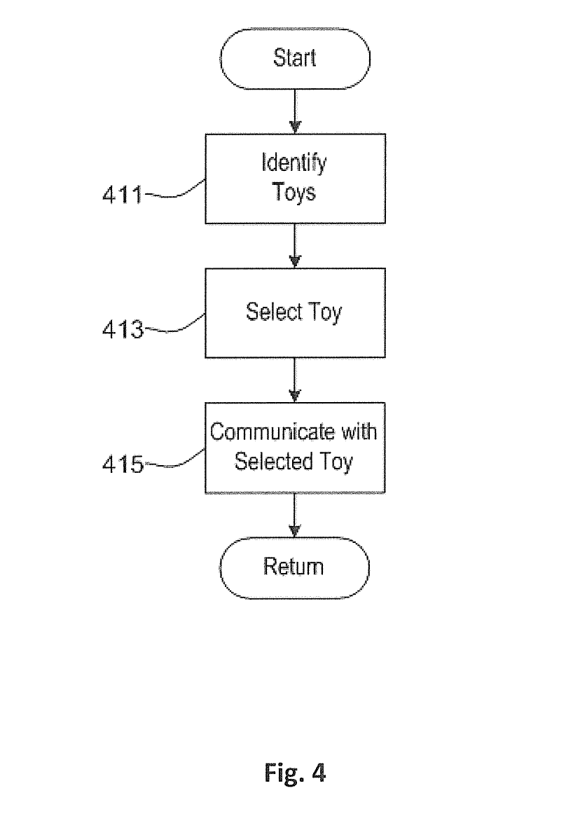

FIG. 4 is a flowchart of a process for communication with toys in accordance with aspects of the invention. The process may be implemented by a videogame peripheral, a videogame console, or a combination of devices. Additionally, the process may be implemented using a processor configured by program instructions. The process may be performed utilizing a standardized protocol, for example, the ISO/IEC 14443 standard for Identification Cards. Accordingly, the process may communicate with toys via radio-frequency communication.

In block 411, the process identifies toys in a defined region. For example, the process may determine what toys are on one or more surfaces of a videogame peripheral (e.g., as described in connection with FIGS. 1 and 3). In various embodiments, the toys may be identified by RFID, barcodes, or optical recognition. In one embodiment, identification of toys includes a videogame peripheral reading identifiers of the toys and supplying the identifiers to a videogame console.

In block 413, the process selects a toy for communication. The process may select the toy by transmitting a selection command having an identifier matching the identifier of the toy. In many embodiments, the process expects to receive an acknowledgment of the selection from the toy. When an acknowledgment is not received, the process may retransmit the selection command or may signal a videogame associated with the process that the selected toy is not available.

In block 415, the process communicates with the selected toy. For example, the process may read from a particular memory location of the toy or may write to a particular memory location of the toy. In many embodiments, the process expects to receive an acknowledgment or response from the toy, and when not received, the process may retransmit the command or may signal the videogame associated with the process that the selected toy is not available. The process thereafter returns.

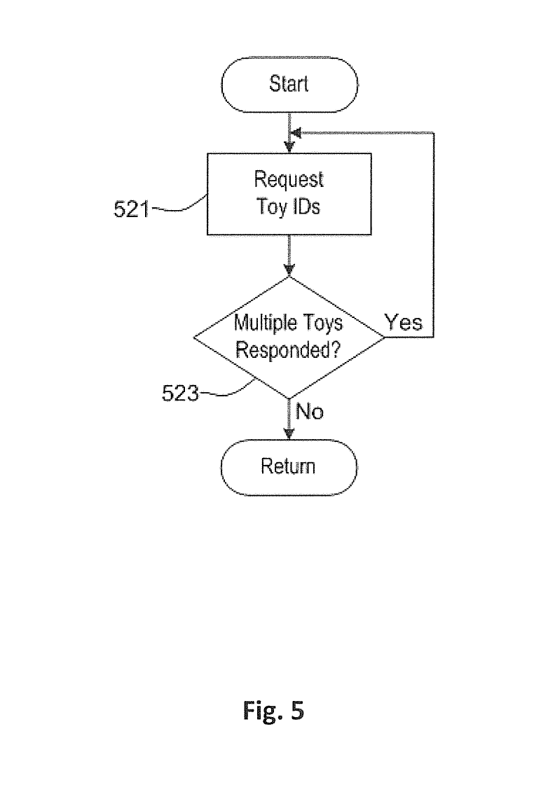

FIG. 5 is a flowchart of a process for identifying toys in accordance with aspects of the invention. The process may be performed as part of a process for communication with toys such as the process of FIG. 4. Accordingly, the process may be performed by a videogame console, a videogame peripheral, or a combination of devices, and the process may use a processor configured by program instructions.

In block 521, the process requests that toys send their identifiers. For example, in an embodiment of the process that uses the ISO/IEC 14443 protocol, the process may transmit a request command (REQA) or a wake-up command (WUP). The process listens for and receives any responses to the request that toys send their identifiers. Each identifier is generally unique to a particular toy.

In block 523, the process determines whether multiple toys responded to the request sent in block 521. For example, multiple toys may respond when there are multiple toys in a region that receives the request of block 521. The process may determine that multiple toys responded by detecting a collision between identifiers in the responses received in block 521. When the process determines that multiple toys responded, the process returns to block 521; otherwise, the process returns. The process may also determine that no toys responded. In various embodiments, the process may return when no toys responded or may return to block 521.

The process may, in block 521, include a range of identifiers in the request that toys send their identifiers. For example, the process may include a string of bits (for example, least-significant bits) in the request with only toys having identifiers with starting bits having values that match the string being requested to send their identifiers. The process may iterate through block 521 and block 523 with an increasingly narrow range of identifiers in the request until an identifier is individually received from each toy. The string of bits included in the request that toys send their identifiers may include the bits that were received by the process in block 521 prior to the collision detected in block 523 followed by a zero bit, and in a subsequent iteration followed by a one bit. For example, after sending a request for all toys to send their identifiers, the process may receive a one bit and a zero bit followed by a collision of bit values. The process accordingly requests toys whose identifiers start with one, zero, and zero to send their identifiers, and depending on the response or responses received may add additional bits to the string of bits in the request for identification. The process later requests toys whose identifiers start with one, zero, and one to send their identifiers, and depending on the response or responses received may add additional bits to the string of bits in the request for identification. The process may iterate through block 521 and block 523 performing a binary tree search for identifiers.

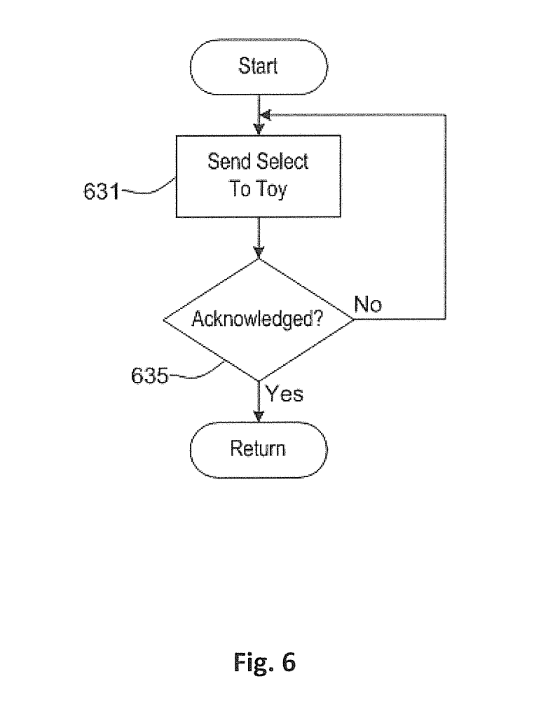

FIG. 6 is a flowchart of a process for selecting a toy in accordance with aspects of the invention. The process may be part of a process for communication with toys such as the process of FIG. 4. Accordingly, the process may be performed by a videogame console, a videogame peripheral, or a combination of devices, and the process may use a processor configured by program instructions.

In block 631, the process selects a toy for further communication. The process may, for example, select the toy by sending a select command (SEL) that includes the identifier of the selected toy.

In block 635, the process determines whether it received an acknowledgment from the toy in response to the selection of block 631. The process may, for example, determine that it received an acknowledgment when it receives a selection acknowledge (SAK) message from the selected toy. When the process determines that it has received an acknowledgment, the process returns; otherwise, the process returns to block 631 to retry selecting the toy. In other embodiments, the process may return when an acknowledgment has not been received. When the process does not receive an acknowledgment, the process may additionally inform a videogame associated with the process that the selected toy is not present.

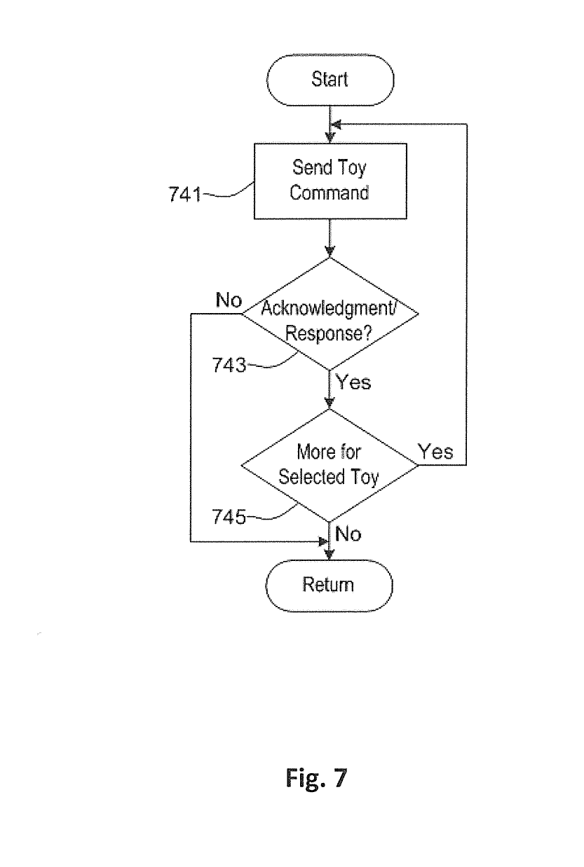

FIG. 7 is a flowchart of a process for communicating commands with a toy in accordance with aspects of the invention. The process may be as part of a process for communication with toys such as the process of FIG. 4. Accordingly, the process may be performed by a videogame console, a videogame peripheral, or a combination of devices, and the process may use a processor configured by program instructions.

In block 741, the process sends a command to the toy. For example, the process may send a read command to acquire data from the toy or a write command to supply data to the toy. Accordingly, the command may include an address value indicating a memory location in the toy to be accessed.

In block 743, the process determines whether it received an acknowledgment from the toy in response to the command sent in block 741. The process may, for example, determine that it received an acknowledgment when it receives a message containing a positive acknowledgment (ACK) from the toy. For a read command, the acknowledgment may include the data read. When the process determines that it has received an acknowledgment, the process continues to block 745; otherwise, the process returns. In other embodiments, the process may return to block 741 to retry sending the command when an acknowledgment has not been received. When the process does not receive an acknowledgment, the process may additionally inform a videogame associated with the process that the toy with which communication is sought is not present.

In block 745, the process determines whether it has any more commands to send to the toy. The process may determine that it has more commands for the toy, for example, by checking a list of actions in the videogame associated with the process. When the process determines that there are more commands for the toy, the process returns to block 741; otherwise, the process returns.

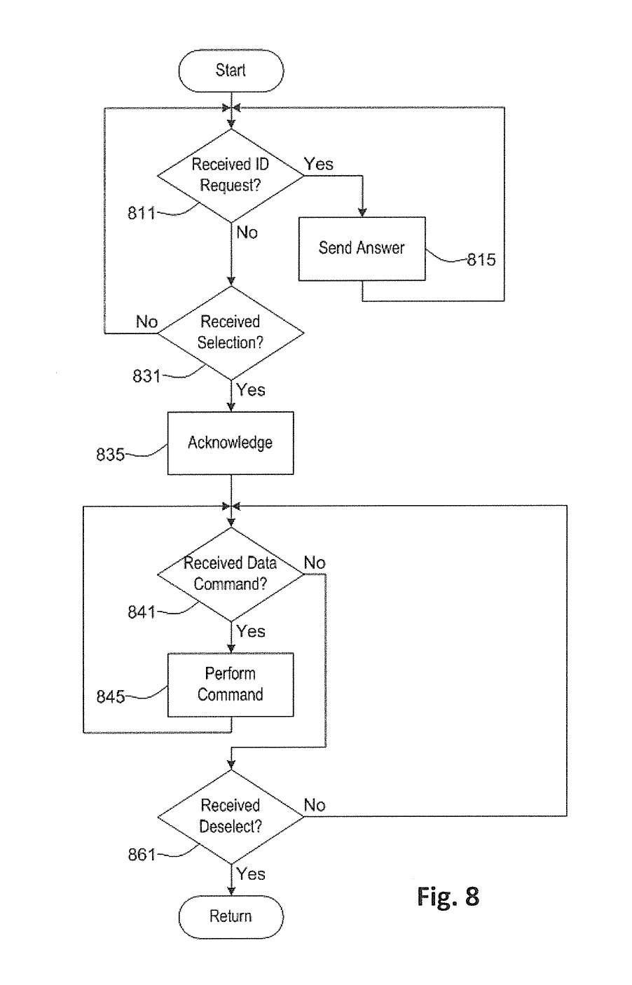

FIG. 8 is a flowchart of a process for communication with a videogame peripheral in accordance with aspects of the invention. The process may be implemented by a toy used in a videogame, for example, one of the toys as shown in FIG. 1. The process may be performed utilizing a standardized protocol, for example, the ISO/IEC 14443 standard for Identification Cards. Accordingly, the process may communicate with a videogame peripheral via radio-frequency communication. Furthermore, the process may communicate with a videogame peripheral that performs any of the processes illustrated in FIGS. 4-7.

In block 811, the process determines whether it has received a request for an identifier associated with the toy. For example, in an embodiment of the process that uses the ISO/IEC 14443 protocol, the process may determine whether it has received a request command (REQA) or a wake-up command (WUP). A request for an identifier may include a range of identifiers that are requested to respond, and the process determines that it has received a request for its identifier when its identifier is within the requested range of identifiers. When the process determines that it has received a request for its identifier, the process continues to block 815; otherwise, the process continues to block 831.

In block 815, the process sends an answer to the request for its identifier. The answer generally includes the identifier or a portion of the identifier. For example, the request for the identifier may have included a portion of the identifier with the process including the remaining portion of the identifier in the answer. Thereafter, the process returns to block 811.

In block 831, the process determines whether it has been selected for further data communication. The process may, for example, determine that it has been selected when a select command (SEL) is received that includes the identifier of the toy. When the process determines that it has been selected, the process continues to block 835; otherwise, the process returns to block 811.

In block 835, the process acknowledges the selection determined in block 831. The process may, for example, transmit a selection acknowledge (SAK) message.

In block 841, the process determines whether it has received a data command. The process may, for example, determine that it has received a command instructing it to read data from or write data to a memory. When the process determines that it has received a data command, the process continues to block 845; otherwise, the process continues to block 861.

In block 845, the process performs the command of block 841. For example, the process may perform a read command by reading values from the memory and transmitting the values. In another example, the process may perform a write command by writing values supplied with command to the memory and transmitting an acknowledgment of the command. Thereafter, the process returns to block 841.

In block 861, the process determines whether it has been deselected from further data communication. The process may, for example, determine that it has been deselected when it receives a deselect command (DESEL) or a halt command (HLTA). When the process determines that it has been deselected, the process returns; otherwise, the process returns to block 841. In some embodiments, the process may wait in a halted state until it receives a wake-up command (WUP) before it returns. When the process is in the halted state, it does not respond to identification request commands, selection commands, or data commands.

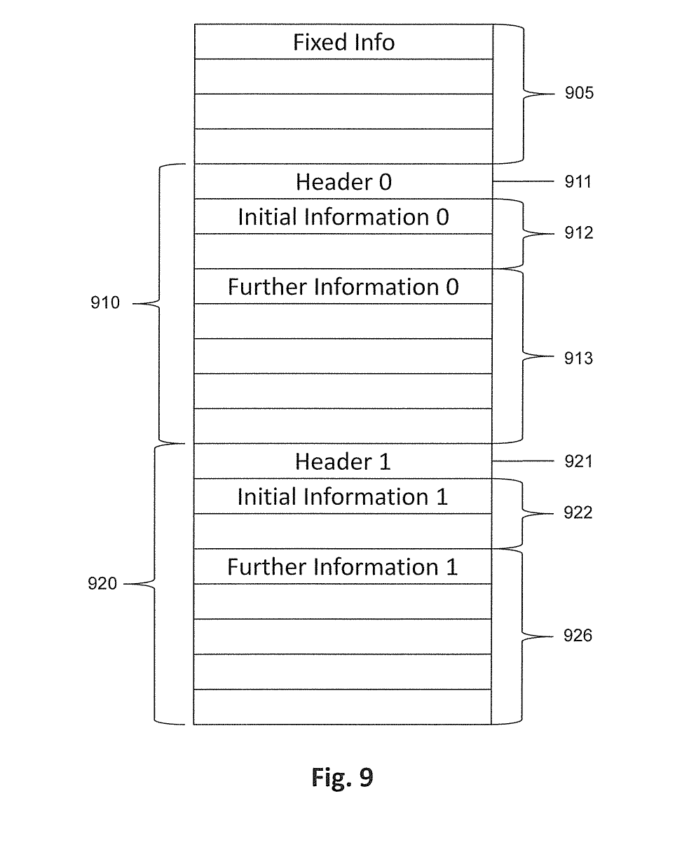

FIG. 9 is a diagram of data structure in accordance with aspects of the invention. The structure may be used to store data in a memory of a toy. Information about the toy, such as its characteristics and its status, are stored at various locations in the data structure. Although various fields of the data structure are shown in particular locations in FIG. 9, the data structure may use a different arrangement of the fields.

The data structure includes an area of fixed information 905. The fixed information includes information that identifies a type of toy and a particular instance of the toy, for example, the fixed information may include a 32-bit serial number. The fixed information may also include an identification of objects related to the toy, such as an identification of a trading card. The fixed information generally includes a field for data verification, for example, a cyclic-redundancy check value or checksum. The fixed information is generally written when the toy is created and not thereafter changed.

The data structure also includes a first data area 910 and a second data area 920. Each of the data areas contains corresponding fields for certain values representing status information about a game play character associated with the toy. However, the first data area and the second data area contain values that reflect the toy's status at different times. For example, the first data area may contain current values and second data area may contain previous values. How which of the data areas is current may be determined and controlled is described further below.

The first data area 910 includes a first header 911. The first header includes information about the toy that may change frequently during game play, such as fields that store score values, experience levels, or money values. The first header may also include a field indicating how much cumulative time the toy has been used for game play. The first header also contains a sequence field that may be used to determine whether the first data area contains current data.

The first data area 910 includes a first initial information area 912. The first initial information area includes information about the toy for use in adding the character associated with the toy to game play. For example, the first initial information area may include a field that stores a name for the toy. The first initial information area may include additional fields that store information useful for displaying a representation of the character associated with the toy in the game. For example, there may be information indicating upgrades that have been acquired for the character associated with the toy or objects the character may be wearing, such as hats or using such as weapons. In some embodiments, however, the fixed information may contain sufficient information for adding the character associated with to the toy to game play, with the fixed information used instead of the initial information.

The first data area 910 includes a first further information area 913. The first further information area includes fields that indicate additional information about the character's status beyond the information contained in the first header and the first initial information area. The fields in the first further information area may include, for example, a value indicating when the character associated with the toy most recently joined the game, a value indicating when the toy was first used in the game, an indication of a player to which the toy belongs, and an indication of what challenges or skill tests the character associated with the toy has completed in the game.

The first data area generally includes one or more fields for data verification, for example, checksums. In one embodiment, the first header includes three checksums: a checksum for the entire first data area, a checksum for the initial information area, and a checksum for the header itself. The inclusion of three checksums may allow the corresponding areas to be verified or updated without reading or writing other areas.

The second data area 920 includes a second header 921, a second initial information area 922, and a second further information area 923. Each of the areas in the second data area corresponds to a like named area in the first data area. In some embodiments, the data structure includes additional data areas, for example, a third data area and a fourth data area.

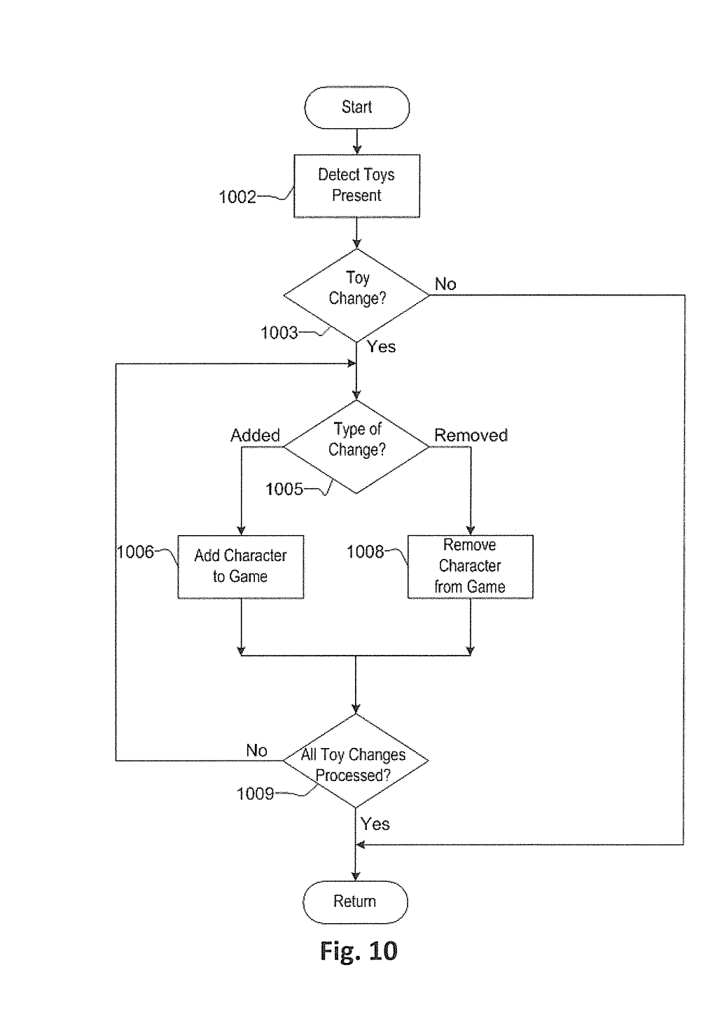

FIG. 10 is a flowchart of a process for reading information from a toy in accordance with aspects of the invention. The process may be performed by a videogame console, a videogame peripheral, or a combination of devices, and the process may use a processor configured by program instructions. Additionally, the process is generally performed repeatedly during play of the videogame, for example, every second.

In block 1002, the process detects toys present on or near a toy reader. In some embodiments, the process detects toys using a videogame peripheral as described with reference to FIG. 3, and the process may detect which toys are present using a process as described with reference to FIG. 5.

In block 1003, the process determines whether there has been a change in the toys present. For example, the process may compare identifiers of the toys detected in block 1002 to a list of toy identifiers currently considered present in the videogame or detected on a prior execution of the process. In some embodiments, the process may use a count of the toys present to determine a change in the toys present. When the process determines that there has been a change in the toys present, the process continues to block 1005; otherwise, the process returns.

In block 1005, the process determines a type of change in the toys present. When the process determines that the type of change in the toys present includes an addition of a toy, the process continues to block 1006; when the process determines that the type of change in the toys present includes a removal of a toy, the process continues to block 1008. When the type of change includes both addition and removal, the process, in various embodiments, may determine the type of change based on a fixed priority, a dynamic priority, or randomly depending, for example, on characteristics of the videogame. In other embodiments, the process may continue to block 1006 and block 1008 concurrently.

In block 1006, the process adds a character associated with an added toy to the videogame. For example, the process may display a representation of the character in the game and include the character in game play. When multiple toys have been added the process may select one of the toys to be added first. For example, the process may select a toy based on a prioritization or randomly. In other embodiments, the process may add characters associated with multiple toys concurrently. Thereafter the process continues to block 1009.

In block 1008, the process removes the character associated with a removed toy from the videogame. For example, the process may remove display of a representation of the character from the game and exclude the character from subsequent game play. When multiple toys have been removed the process may select one of the toys to be removed first. In other embodiments, the process may remove multiple toys concurrently. Thereafter the process continues to block 1009.

In block 1009, the process determines whether all of the changes in toys present have been processed. The process may, for example, form a list of changes in block 1003 and remove toys from the list when the toys are added to the game in block 1006 or removed from the game in block 1008. When the process determines all of the changes have been processed, the process returns; otherwise, the process returns to block 1005.

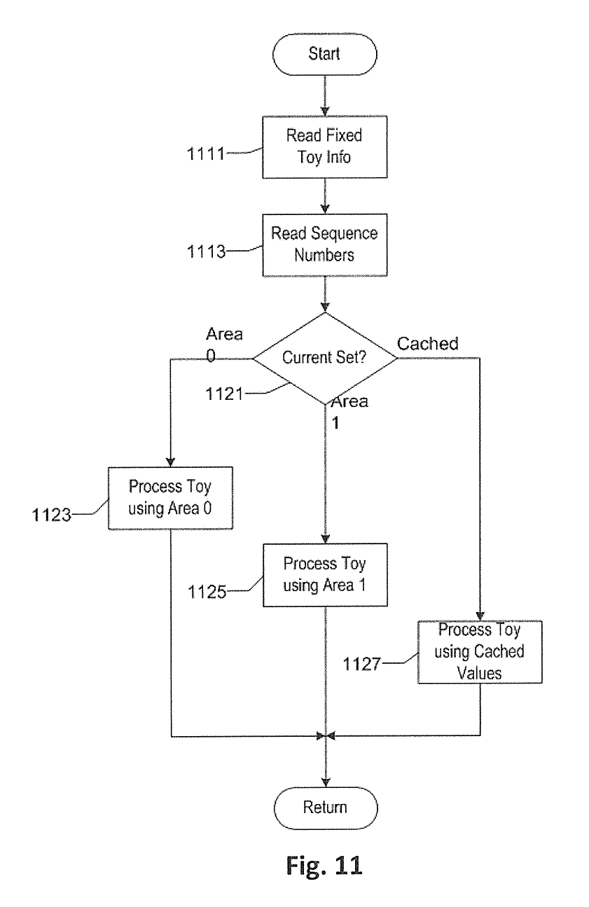

FIG. 11 is a flowchart of a process for adding characters in a videogame in accordance with aspects of the invention. The process may be performed by a videogame console, a videogame peripheral, or a combination of devices, and the process may use a processor configured by program instructions. The process of FIG. 11 may be performed in association with the process for changing characters present in a videogame of FIG. 10. Additionally, the process may be used with toys that store information in a data structure as illustrated by FIG. 9. Multiple instances of the process may be concurrently, for example, an instance of the process for each of multiple toys.

In block 1111, the process reads fixed information from a toy. The information may be read using a process as shown in FIG. 4. The fixed information includes values that uniquely identify the toy and type of toy.

In block 1113, the process reads sequence values for each of multiple data areas of toy information. The flowchart of FIG. 11 illustrates a process for toys with two data areas, data area 0 and data area 1, but other numbers of data areas may be used. The sequence numbers may be stored in headers of the data areas. Each sequence value indicates when, in comparison to other headers, the header was written. For example, the sequence value may be incremented modulo a maximum value each time a header is written. The process may, in some embodiments, also determine a sequence number for cached data values associated with the toy. The videogame may save data values for the toy in a cache from when the toy was previously played in the game. The cached data values may, for example, be useful when they contain updated values that had not been written to the toy before the toy was previously removed from the videogame.

In block 1121, the process determines which sequence value is most recent. The process may order the sequence values according to the order in which they would be generated and select the last in sequence as the most recent. When the process determines that the sequence value from data area 0 is most recent, the process continues to block 1123; when the process determines that the sequence value from data area 1 is most recent, the process continues to block 1125; when the process determines that the cached sequence value is most recent, the process continues to block 1127.

In block 1123, the toy is processed using data area 0. For example, the process may read toy information from data area 0 and use the information to add a character associated with the toy to the videogame. Thereafter the process returns.

In block 1125, the toy is processed using data area 1. Processing the toy is generally as for block 1123 except information from data area 1 is used. Thereafter the process returns.

In block 1127, the toy is processed using cached values. Processing the toy is generally as for block 1123 except cached information about the toy is used. Thereafter the process returns.

The process of FIG. 11 may include error checking of information read from the toy. When the process determines that data read from the toy contains an error or is unreliable, it may alter the processing. For example, if one of the sequence numbers read in block 1113 is unreliable, the associated data area may be excluded from further processing.

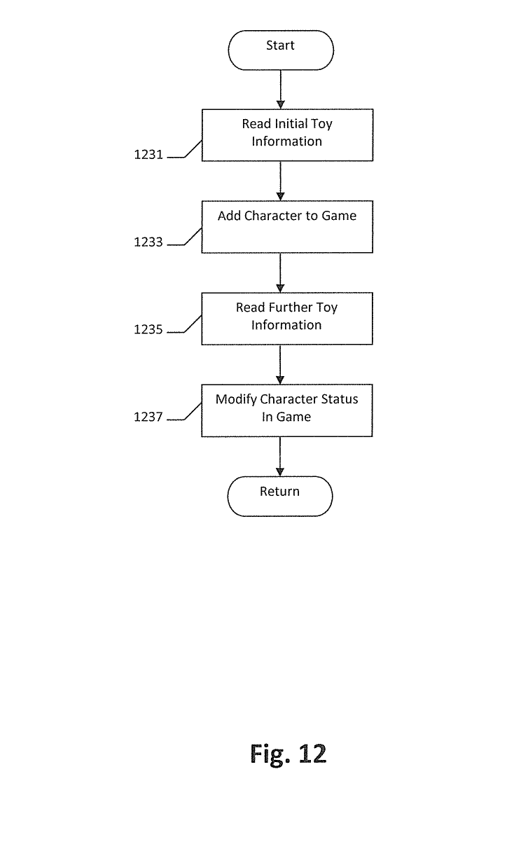

FIG. 12 is a flowchart of a further process for adding characters in a videogame in accordance with aspects of the invention. The process may be performed by a videogame console, a videogame peripheral, or a combination of devices, and the process may use a processor configured by program instructions. The process of FIG. 12 may be performed as part of block 1006 of the process of FIG. 10 and also in association with the process of FIG. 11. The process may be used with toys that store information in a data structure as illustrated by FIG. 9.

In block 1231, the process reads initial information from the toy. The initial information includes information about the toy that is used to add the toy to game play. In some embodiments, the initial information is read using a process illustrated by FIG. 4. In some embodiments, the initial information includes a name of the toy and objects the toy is wearing. In one embodiment, the process commands a videogame peripheral to read the initial information from the toy. In another embodiment, the process may receive initial information that had previously been read by a videogame peripheral.

In block 1233, the process adds the toy to the videogame. For example, the process may display a representation of a character associated with the toy or an animated sequence for the character on the display screen of the videogame system illustrated by FIG. 1. Displaying the character utilizes the initial information read in block 1231. The process also makes the character available for subsequent game play.

In block 1235, the process reads further information from the toy. The further information is generally read in the same manner the initial information was read in block 1231. The further information may include, for example, a value indicating when the toy most recently joined the game, a value indicating when the toy was first used in the game, an indication of which player the toy belongs to, and an indication of what challenges or skill tests the character associated with the toy has completed in the game, and various information related to the status, for example the capabilities, of the character associated with the toy, for example as may have been modified or changed as a result of prior game play. The further information combined with the fixed and/or initial information generally includes complete information available from the toy.

In block 1237, the process modifies status of the character associated with the toy in the videogame. For example, the process may add details read in block 1235 to the character representing the toy and to the status of the character in the videogame. Thereafter the process returns.

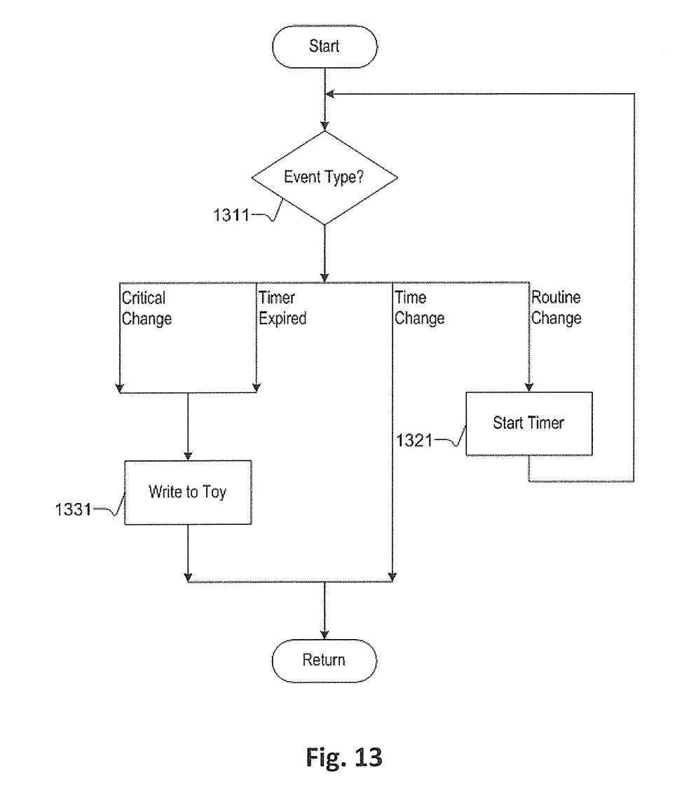

FIG. 13 is a flowchart of a process for processing events that update toy information in accordance with aspects of the invention. The process is performed in association with a videogame and may be performed by, for example, the videogame console of FIG. 1 or the processor of FIG. 2, as configured by program instructions, in conjunction with associated circuitry. The process may be used with toys that store information in a data structure as illustrated by FIG. 9. Additionally, multiple instances of the process may be performed concurrently, for example, performing an instance of the process for each of multiple toys.

In block 1311, the process determines a type of event that may result in updating information in the toy. The process may determine the event type based at least in part on game play events.

In block 1311, if the process determines that the event type is a time change, the process returns. That is, a time-change event does not result in the process currently writing information to the toy. In some embodiments, the process writes time-based information, for example, a cumulative play time value or a last time played, to the toy when another event causes the process to write other information to the toy.

In block 1311, if the process determines that the event type is a critical type, the process continues to block 1331. A critical-type event is an event for which it is desirable to quickly update information in the toy. Critical-type events may include, for example, changes to the toy's name, changes to performance levels of the toy, or acquisition of upgrades for the toy.

In block 1311, if the process determines that the event type is a routine type, the process continues to block 1321. A routine-type event is an event for which writing information to the toy may be deferred. Routine-type events may include, for example, changes to the toy's score or changes to the experience level of the toy. Routine-type events may occur frequently during game play and thus it may be desirable to otherwise use the time that would be used to write to the toy, for example, to process information for another toy.

In block 1321, the process starts a timer. For example, the process may start a timer that expires in three seconds. When the timer is already running, the process may, in various embodiments, restart the timer or let it continue running from its current state. The process thereafter returns to block 1311.

Referring again to block 1311, when the timer expires, the process continues to block 1331.

In block 1331, the process writes information to the toy. The process may write information to the toy by commanding a videogame peripheral, such as the videogame peripheral of FIG. 2, to perform the write. The written information generally corresponds to the event analyzed in block 1311. For example, when the event is an event to change the toy's name, a new name is written to the toy. Additional information may also be written to the toy. For example, time-based information or information based on a routine-type event may be written to the toy concurrently with writing information based on a critical-type event. The timer started in block 1321 is stopped when the process writes information to the toy related to the routine-type event that resulted in starting the timer. Although the timer started in block 1321 is not used for critical-type events, the process may incur incidental delays before writing information to the toy in block 1331. Thereafter the process returns.

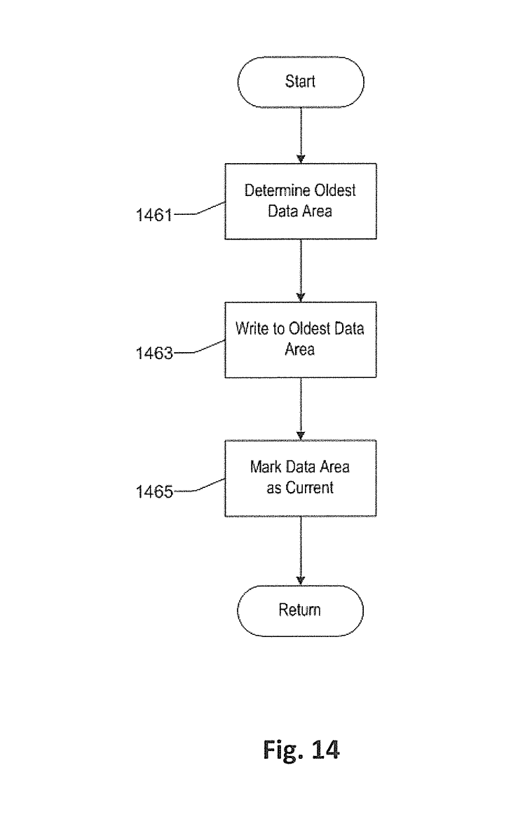

FIG. 14 is a flowchart of a process for writing information to a toy in accordance with aspects of the invention. The process is performed in association with or as part of a videogame. The process may be performed by a videogame console, a videogame peripheral, or a combination of devices, and the process may use a processor configured by program instructions. The process of FIG. 14 may be performed in association with the process for updating toy information of FIG. 13 and may be used with toys that store information in a data structure as illustrated by FIG. 9. Additionally, multiple instances of the process may be performed concurrently, for example, an instance of the process for each of multiple toys.

In block 1461, the process determines the oldest of multiple data areas in the toy. The process may determine the oldest data area using sequence values in a manner analogous to that used to determine the current data area in the process of FIG. 11. In a particular embodiment in which there are two data areas in the toy, the oldest data area is the data area that is not the current data area.

In block 1463, the process writes to the data area determined to the oldest in block 1461. Writes may be performed using a process as shown in FIG. 4. In some embodiments, the process compares the data to be written to the toy with data previously read from the toy and omits writes would not change values in the toy.

In block 1465, the process marks the data area written to in block 1463 as the current data area. For data areas with sequence values, the process writes the next value in the sequence to the toy. For example, the sequence value from the previously current data area may be incremented, modulo a maximum value, and written to the toy.

The process, in many embodiments, verifies that the information writes to the toy were successful. For example, the process may read the values back from the toy and compare the results to the expected values. In the event of an error, the process may retry writing the information to the toy. Additionally, the process may write to the toy in blocks of data and in a particular order, for example, a checksum for the data may be written last.

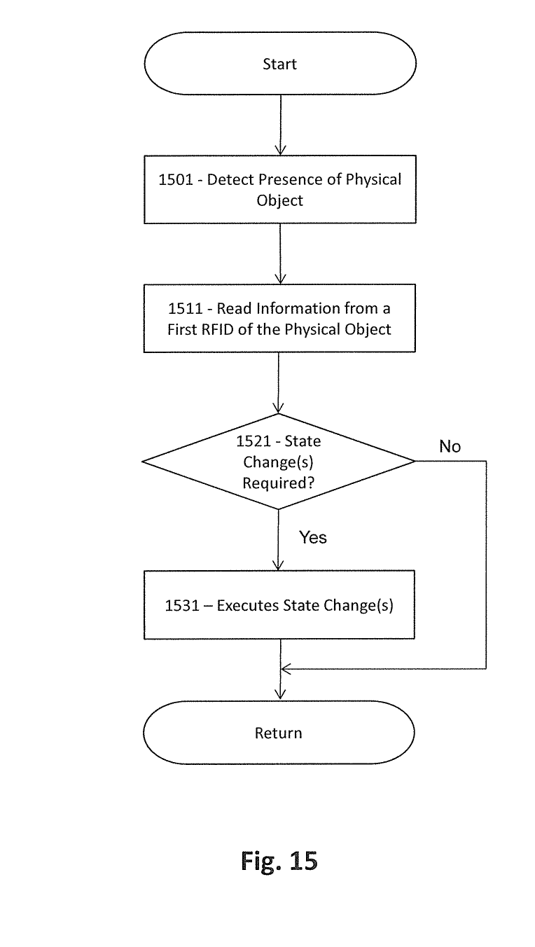

FIG. 15 is a flowchart of a process for conducting videogame gameplay in accordance with aspects of the present invention. The process may be performed by a videogame device, a videogame peripheral, or a combination of devices, and the process may use a processor configured by program instructions. In some embodiments the processed may be performed by the system or portions of the system of FIG. 1A.

In block 1501, the process detects the presence of a physical object. In some embodiments, the process uses a peripheral to detect the presence of the physical object. In some embodiments, the detection device may be included in the videogame device. In some embodiments, the physical object may be detected when it is placed within one or more detection areas of the peripheral or videogame device. The physical object may be any physical object including a plurality of machine-readable components, for example, the physical objects of FIGS. 1A-1C.

In block 1511, the process reads information from a first machine-readable component of the physical object. The machine-readable component may be, for example, an RFID tag, optically-readable component, or any other machine-readable component. In some embodiments, the process may read the entire contents of the machine-readable component or, alternatively, only read from certain locations of the machine-readable component (e.g., certain addresses, address ranges, bits, or registers of the component).

In block 1521, the process determines whether a state change is required in the videogame based on the information read from the first machine-readable component. The information read from the first machine-readable component may comprise information directly relating to one or more videogame states. For example, the information may comprise the name, code, or identification of one or more videogame states, commands to change/toggle one or more videogame states, or commands to enter one or more videogame states. Additionally or alternatively, the information may comprise information that indirectly relates to one or more videogame states. For instance, the information may identify the physical object or a portion thereof, and the videogame may use that information to change one or more videogame states. In some embodiments the machine-readable component stores information identifying a virtual game character or virtual object for a videogame. In some embodiments the machine-readable component includes some or all of the information of the data structure of FIG. 9.

As discussed throughout this disclosure, any videogame state may be set, but non-limiting examples of videogame states include time of day, day or night, whether certain characters or character classes are awake or asleep, whether certain abilities or characteristics are enabled for certain characters or character classes, weather, the level or effect of gravitational forces, the rate at which time passes, whether certain characters or character classes can sustain damage, whether the videogame is in a bonus state, magic state, technology state, or some other defined state of the videogame.

If a state change is required, the process proceeds to block 1531. Otherwise, the process returns.

In block 1531, the process executes the required state change(s).

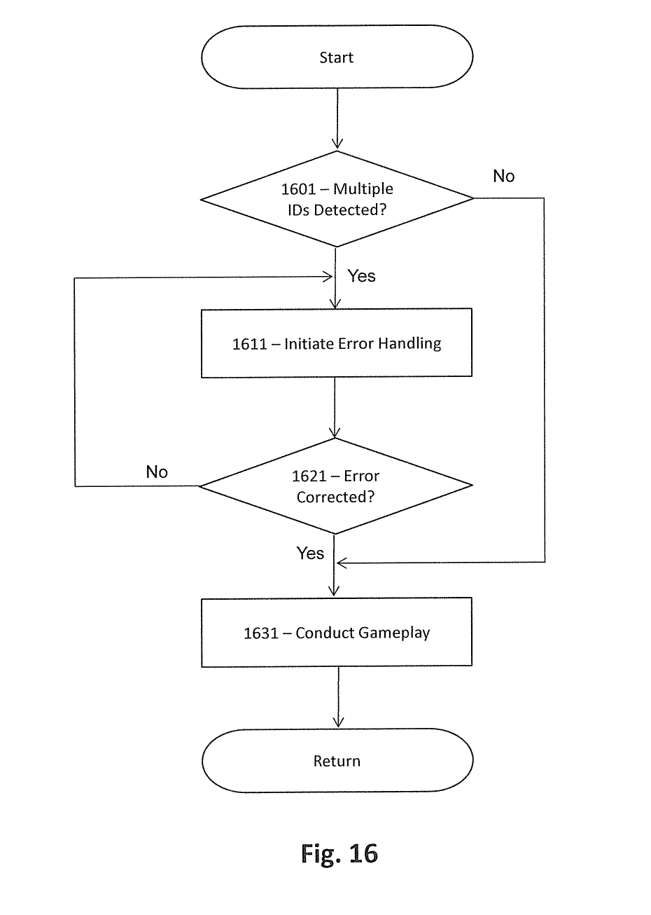

FIG. 16 is a flowchart of a process for conducting videogame gameplay in accordance with aspects of the present invention. The process may be performed by a videogame device, a videogame peripheral, or a combination of devices, and the process may use a processor configured by program instructions. In some embodiments the processed may be performed by the system or portions of the system of FIG. 1A.

In block 1601, the process determines if multiple machine-readable components from a single physical object have been detected. If the process has detected multiple machine-readable components from a single physical object, the process proceeds to block 1611 to initiate error handling. Otherwise, the process proceeds to block 1631 and conducts gameplay. In some embodiments, the process uses a peripheral to detect the machine-readable components. In some embodiments, the detection device may be included in the videogame device. In some embodiments, the machine-readable components may be detected when the physical object is placed within one or more detection areas of the peripheral or videogame device. The physical object may be any physical object including a plurality if machine-readable components, for example, the physical objects of FIGS. 1A-1C.

In block 1611, the process initiates error handling. In some embodiments, error handling comprises prompting the user. In some embodiments, prompting the user comprises displaying a dialogue in the videogame instructing the user on how to troubleshoot the error (e.g., by repositioning the physical object within the detection area or ensuring the physical object is properly placed on a stand portion of the physical object). In some embodiments, the prompting the user comprises displaying a dialogue in the videogame querying the user to select which of the multiple machine-readable components should be used in the videogame. In some embodiments, the prompt comprises an indication of error on the peripheral device (e.g., red flashing lights, an audio error message, or any other audiovisual indication). In some embodiments, the process may attempt to determine which of the detected machine-readable components should be used by the videogame (e.g., by determining the machine-readable component with the strongest signal strength) and, optionally, query the user to confirm the determination.

In block 1621, the process determines whether the error has been corrected, for example, if only one machine-readable component is detected or in response to a user selection. If the error has been corrected, the process proceeds to block 1631 and conducts gameplay. Otherwise, the process returns to block 1611 and repeats the error handling routine.

Although the invention has been discussed with respect to various embodiments, it should be recognized that the invention comprises the novel and non-obvious claims supported by this disclosure.

What is claimed is:

1. A videogame, comprising:
an RFID reader comprising at least one substantially flat surface;
a toy comprising a plurality of portions, each portion comprising an RFID tag readable by the RFID reader;
wherein the plurality of portions of the toy are configured such that when the toy is placed on the at least one substantially flat surface of the RFID reader, a first RFID tag of the toy, and only the first RFID tag of the toy, is sufficiently proximate the RFID reader such that the RFID reader can read information from the first RFID tag; and
wherein information read by the RFID reader from the first RFID tag is used by a videogame.

2. The videogame system of claim 1, wherein the first RFID tag of the toy comprises information relating to a state of the videogame.

3. The videogame system of claim 2, wherein the state of the videogame relates to the time of day or whether it is currently day or night.

4. The videogame system of claim 2, wherein the state of the videogame relates to whether the videogame is in magic state or technology state.

5. The videogame system of claim 2, wherein the state of the videogame relates to whether certain characters or character classes are awake or asleep.

6. The videogame system of claim 1, wherein the plurality of portions consists of two portions.

7. The videogame system of claim 1, wherein the plurality of portions consists of six portions.
